(19) United States
(12) Patent Application Publication
(10) Pub. No.: US 2009/0152898 A1
(43) Pub. Date: Jun. 18, 2009

(54) Pipe member and method of manufacturing the same

(75) Inventors: Tomohiko Kawamura, Mie (JP); Makoto Takano, Mie (JP); Hiroshi Kashima, Mie (JP)

Correspondence Address: CARRIER BLACKMAN AND ASSOCIATES, 24101 NOVI ROAD, SUITE 100, NOVI, MI, 48375, US

(73) Assignee: Bestex Kyoei Co., Ltd., Yokkaichi-shi (JP)

(21) Appl. No.: 12/284,429

(22) Filed: Sep. 22, 2008

(30) Foreign Application Priority Data
Dec. 14, 2007 (JP) 2007-322667

(51) Int. Cl. B62D 21/02; F16B 11/00

(52) U.S. Cl. 296/193.02; 403/285

(57) ABSTRACT

To provide a pipe member composed of a small-diameter metal pipe and a large-diameter metal pipe integrated via a double pipe structure part. A diameter expanding punch 12 is press-fitted into a small-diameter pipe 3 through a large-diameter pipe 2, thereby integrally expanding the diameter of the small-diameter pipe 3 and the large-diameter pipe 2. As the diameter of the small-diameter pipe 3 is expanded, the longitudinal dimension of an expanded part 3b is shortened, and the tip end of the expanded part 3b of the small-diameter pipe 3 is spaced apart from a step part 2c of the large-diameter pipe 2. In this state, the large-diameter pipe 2 and the small-diameter pipe 3 are displaced with respect to each other in the longitudinal direction. To avoid this, during molding of an expanded part 2b and the expanded part 3b, a part of the expanded part 2b of the large-diameter pipe 2 is radially inwardly deformed by a pin 11 to form a retaining part 5 that is engaged in the expanded part 3b of the small-diameter pipe 3.

### BACKGROUND OF THE INVENTION

1. Field of the Invention

The present invention relates to a pipe member formed by integrally coupling a small-diameter metal pipe and a large-diameter metal pipe, such as a steering hanger beam for automobiles.

2. Description of the Related Art

A steering hanger beam, which is a member laid across the width of an automobile for attaching an instrument panel to the body of the automobile, has to have a higher stiffness on the driver (driver's seat) side than on the assistant (passenger's seat) side. Therefore, a composite pipe member formed by welding two kinds of pipes different in material, outer diameter or thickness is sometimes used for the steering hanger beam. For example, a pipe made of a carbon steel for machine construction (JIS G 3445 STKM11A) and having an outer diameter of 42.7 mm and a thickness of 1.2 mm is used as the pipe on the assistant (passenger's seat) side, an a pipe made of carbon steel for machine construction (JIS G 3445 STKM13B) and having an outer diameter of 60.5 mm and a thickness of 2 mm is used as the pipe on the driver (driver's seat) side, one end of the large-diameter pipe is drawn to an outer diameter equal to that of the small-diameter pipe, and the pipes are bonded by arc welding.

The composite pipe member described above entails the cost of welding. Thus, in the patent literature 1, the applicant has proposed a steering hanger beam formed by press-fitting a metal pipe into another metal pipe having substantially the same diameter and held so that the outer diameter thereof does not change while shrinking the diameter thereof, thereby forming an integral multiple pipe structure part.
Patent literature 1: Japanese Patent No. 3865626

### SUMMARY OF THE INVENTION

According to the method disclosed in the patent literature 1, any part of the pipe member that is required to have a certain stiffness can have the required stiffness. However, the method requires a high mechanical force because the double pipe structure part is formed by press-fitting a metal pipe into another metal pipe having substantially the same diameter and held so that the outer diameter does not change by shrinking the diameter thereof.

In order to solve the problem, the present invention provides a pipe member, comprising: a small-diameter metal pipe; a large-diameter metal pipe; and a double pipe structure part that couples one end of the small-diameter metal pipe to the large-diameter metal pipe, in which the small-diameter metal pipe has an expanded part forming the double pipe structure part and a tapered part connecting the expanded part and a small-diameter metal pipe main body, said large-diameter metal pipe has an expanded part forming the double pipe structure part and a bent part formed at the tip of the expanded part and overlying the tapered part of said small-diameter metal pipe, and the small-diameter metal pipe and the large-diameter metal pipe are fixed in the longitudinal direction.

The small-diameter metal pipe and the large-diameter metal pipe can be fixed in the longitudinal direction with a retaining part, which is formed by integrally radially inwardly or outwardly deforming a part of the expanded part of the small-diameter metal pipe and a part of the expanded part of the large-diameter metal pipe, or by making the expanded part of the small-diameter metal pipe abut against a step part of the large-diameter metal pipe.

A method of manufacturing a pipe member according to the present invention comprises the steps of: inserting a large-diameter metal pipe into a molding die; inserting a small-diameter metal pipe into the large-diameter metal pipe from a direction opposite to the direction of insertion of the large-diameter metal pipe; press-fitting a diameter expanding punch into the small-diameter metal pipe through the large-diameter metal pipe, thereby integrally expanding the diameter of the large-diameter metal pipe and the small-diameter metal pipe; inwardly bending a tip end of an expanded part of the large-diameter metal pipe so that the tip end conforms to a tapered part of the small-diameter metal pipe; and integrally radially inwardly or outwardly deforming a part of an expanded part of the small-diameter metal pipe and a part of the expanded part of the large-diameter metal pipe.

According to the present invention, there is provided a pipe member that is formed by integrating a small-diameter metal pipe and a large-diameter metal pipe via a double pipe structure part in a single step without high mechanical force.

In addition, according to the present invention, two metal pipes can be integrated without performing welding.

### BRIEF DESCRIPTION OF THE DRAWINGS

FIG. 1 is a perspective view showing the appearance of a steering hanger beam, which is a pipe member according to the present invention;

FIG. 2 is an enlarged cross-sectional view of a double pipe structure part;

FIG. 3 is a diagram showing a large-diameter metal pipe and a small-diameter metal pipe inserted in a molding die;

FIG. 4 is a diagram showing the large-diameter metal pipe and the small-diameter metal pipe that are being integrally expanded in diameter;

FIG. 5 is a diagram showing the large-diameter metal pipe and the small-diameter metal pipe completely expanded in diameter;

FIG. 6 is a diagram corresponding to FIG. 5 showing another example; and

FIG. 7 is a diagram corresponding to FIG. 2 showing another example.

### DETAILED DESCRIPTION OF THE PREFERRED EMBODIMENTS

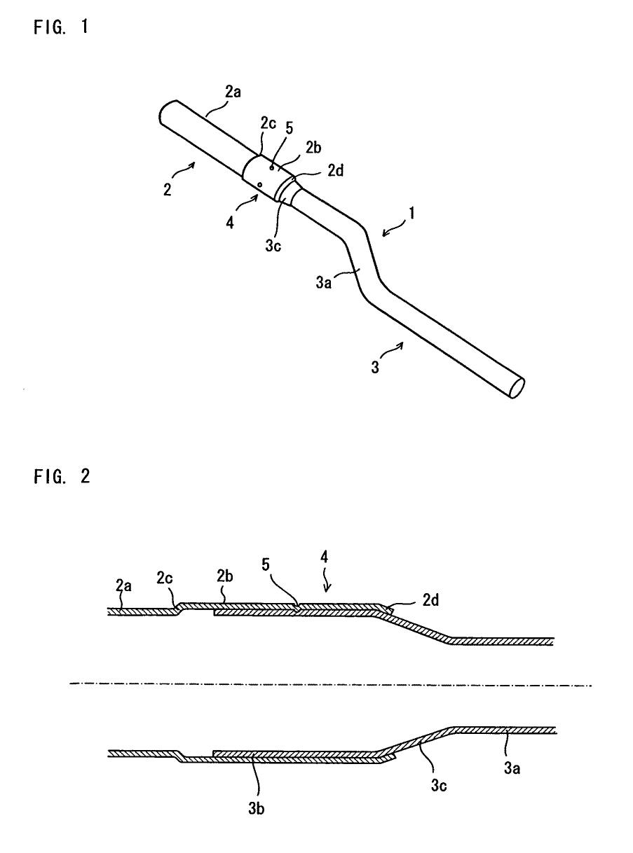

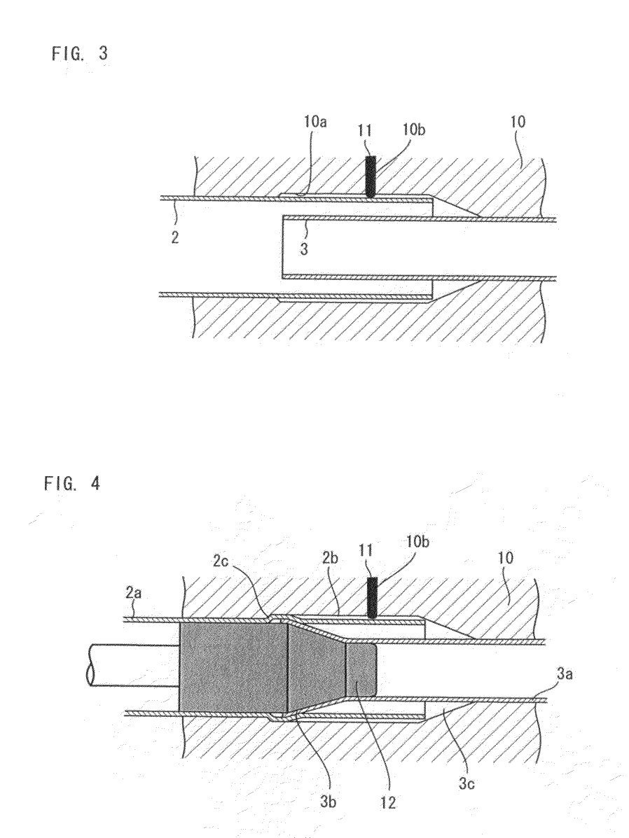

In the following, an embodiment of the present invention will be described with reference to the drawings. FIG. 1 is a perspective view showing the appearance of a steering hanger beam, which is a pipe member according to the present invention. FIG. 2 is an enlarged cross-sectional view of a double pipe structure part. FIG. 3 is a diagram showing a large-diameter metal pipe and a small-diameter metal pipe inserted in a molding die. FIG. 4 is a diagram showing the large-diameter metal pipe and the small-diameter metal pipe integrally expanded in diameter.

A steering hanger beam 1 has a large-diameter pipe 2 disposed on the driver (driver's seat) side and a small-diameter pipe 3 disposed on the assistant (passenger's seat) side integrally coupled to each other by a double pipe structure part 4.

The large-diameter pipe 2 comprises a large-diameter pipe main body 2a, an expanded part 2b, a step part 2c that forms a boundary part between the large-diameter pipe main body 2a and the expanded part 2b, and a bent part 2d at the tip of the large-diameter pipe 2.

The small-diameter pipe 3 comprises a small-diameter pipe main body 3a, an expanded part 3b, and a tapered part 3c that connects the small-diameter pipe main body 3a and the expanded part 3b. The expanded part 2b of the large-diameter pipe and the expanded part 3b of the small-diameter pipe are formed by integral expansion and constitute the double pipe structure part 4.

At the longitudinal midpoint of the part of the expanded part 2b of the large-diameter pipe 2 that lies on the expanded part 3b of the small-diameter pipe 3, the expanded part 2b of the large-diameter pipe 2 is deformed radially inwardly to form a retaining part 5 that is engaged in the expanded part 3b of the small-diameter pipe 3. Three retaining parts 5 equally spaced apart from each other are formed along the circumference of the double pipe structure part 4.

Because of the conformity of the bent part 2d of the large-diameter pipe to the tapered part 3c of the small-diameter pipe and the presence of the retaining part 5, the large-diameter pipe 2 and the small-diameter pipe 3 are firmly fixed in the longitudinal direction without welding. However, the periphery of the bent part 2d can be welded to the small-diameter pipe 3.

Now, a method of manufacturing the pipe member described above will be described with reference to FIGS. 3 and 4. For manufacturing the pipe member, a molding die 10, which is composed of a pair of clamp dies, and a diameter expanding punch 12 are used. The molding die 10 has a recess 10a in each clamp die in which the double pipe structure part 4 is formed. The recess 10a has a depth equal to the thickness of the small-diameter pipe 3.

In addition, three radial holes 10b equally spaced apart from each other and opening into the recess 10a are formed in the circumferential direction, an a pin 11 is fixed in each of the radial holes 10b. The tip of the pin 11 projects into the recess 10a for a length that does not interfere with insertion of the large-diameter pipe 2.

In the molding process using the molding die 10 described above, first, as shown in FIG. 3, the large-diameter pipe 2 is inserted into the molding die 10, and the small-diameter pipe 3 is inserted into the large-diameter pipe 2 from the direction opposite to the direction of insertion of the large-diameter pipe 2. Alternatively, the small-diameter pipe 3 is inserted into the large-diameter pipe 2, and then, the clamp dies of the molding die 10 are closed.

Then, the diameter expanding punch 12 is press-fitted into the small-diameter pipe 3 through the large-diameter pipe 2, thereby integrally expanding the diameter of the small-diameter pipe 3 and the large-diameter pipe 2. As the diameter of the small-diameter pipe 3 is expanded, the longitudinal dimension of the expanded part 3b is shortened, and the tip end of the expanded part 3b of the small-diameter pipe 3 is spaced apart from the step part 2c of the large-diameter pipe 2 as shown in FIG. 4. Therefore, if the retaining part 5 described later is not formed, the large-diameter pipe 2 and the small-diameter pipe 3 are displaced with respect to each other in the longitudinal direction.

The diameter expanding punch 12 is further pressed, thereby forming the expanded part 2b, the step part 2c and the bent part 2d of the large-diameter part and the expanded part 3b and the tapered part 3c of the small-diameter pipe at the same time. Then, as shown in FIG. 5, during molding of the expanded parts 2b and 3b, a part of the expanded part 2b of the large-diameter pipe 2 is deformed radially inwardly by the pin 11 to form the retaining part 5 that is engaged in the expanded part 3b of the small-diameter pipe 3.

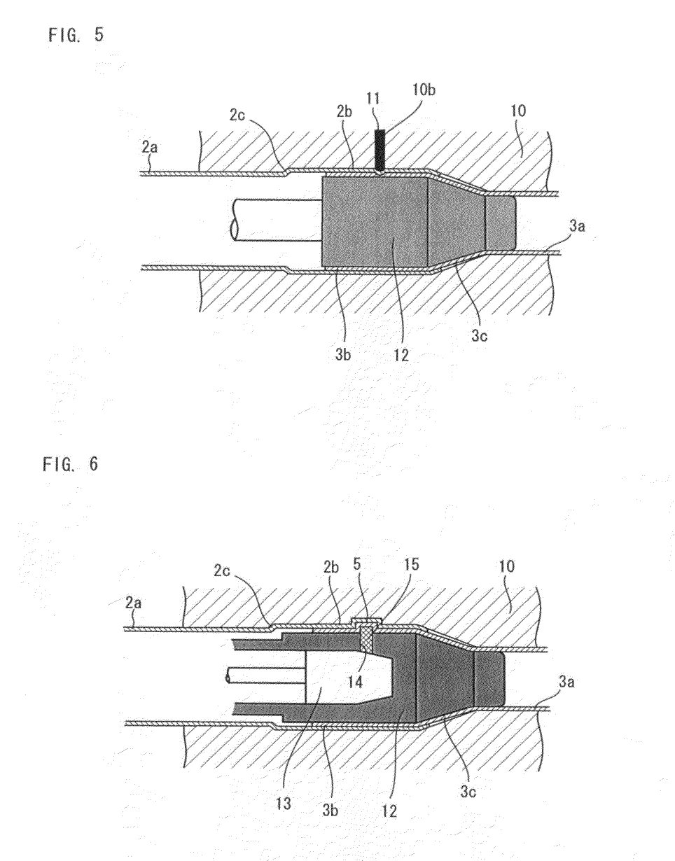

FIG. 6 is a diagram showing another example of formation of the retaining part 5. In this example, an inner punch 13, which is slidable in the longitudinal direction, is disposed in the diameter expanding punch 12, a radial through-hole 14 is formed in the diameter expanding punch 12, and a pin 15 is inserted in the through-hole 14.

With this arrangement, a retaining part 5 can be formed in a single molding step. That is, when the inner punch 13 enters the diameter expanding punch 12, the tapered tip part of the inner punch 13 pushes the pin 15 radially outwardly, and the pin 15 presses a part of the large-diameter pipe 2 and the small-diameter pipe 3 together radially outwardly to form a retaining part 5.

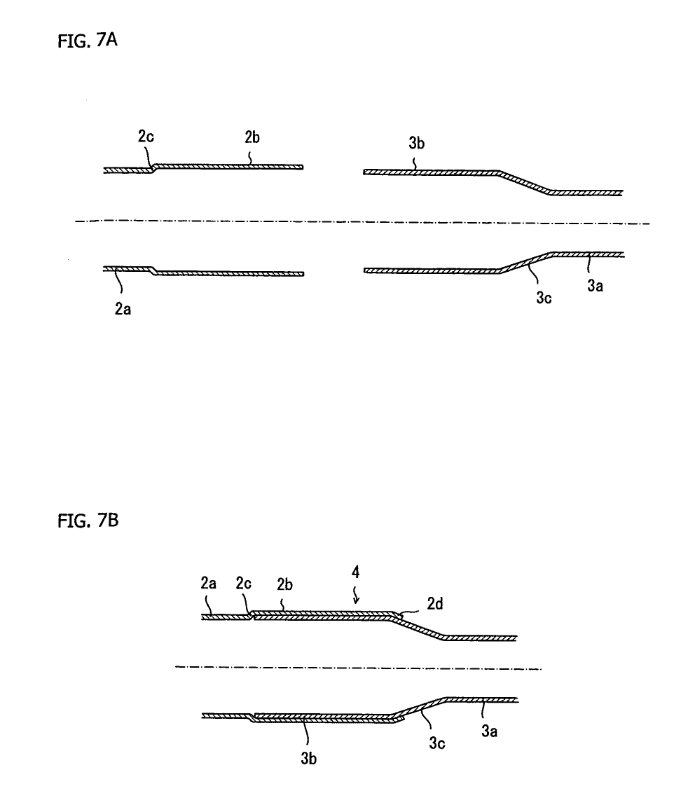

FIG. 7 includes diagrams corresponding to FIG. 2 and showing another example. In this example, the retaining part 5 is not formed. Instead, the tip end of the expanded part 3b of the small-diameter pipe 3 is made to abut against the step part 2c of the large-diameter pipe 2, so that the small-diameter pipe 3 is firmly held between the step part 2c and the bent part 2d and fixed in the longitudinal direction. However, the longitudinal dimension of the expanded part 3b of the small-diameter pipe 3 is shortened during molding. Therefore, to form the double pipe structure part 4 having this configuration, the expanded parts of the large-diameter pipe 2 and the small-diameter pipe 3 are formed separately as shown in FIG. 7(a), and then, the expanded part 3b of the small-diameter pipe 3 is press-fitted into the expanded part 2b of the large-diameter pipe 2 until the tip end of the expanded part 3b of the small-diameter pipe 3 comes into contact with the step part 2c as shown in FIG. 7(b), and finally, the bent part 2d is formed.

1. A pipe member, comprising:
a small-diameter metal pipe;
a large-diameter metal pipe; and
a double pipe structure part that couples one end of the small-diameter metal pipe to the large-diameter metal pipe,
wherein said small-diameter metal pipe has an expanded part, a tapered part, and a main body, the expanded part partially forming the double pipe structure part and the tapered part connecting the expanded part and the main body,
said large-diameter metal pipe has an expanded part partially forming the double pipe structure part and a bent part formed at a tip of the expanded part and overlying the tapered part of said small-diameter metal pipe, and
the small-diameter metal pipe and the large-diameter metal pipe are fixed in a longitudinal direction thereof.

2. The pipe member according to claim 1, further comprising a fixing part which fixes said small-diameter metal pipe and said large-diameter metal pipe in the longitudinal direction, wherein the retaining part includes a radially inward or outward deformation formed integrally in the expanded parts of said small-diameter and large-diameter metal pipes.

3. The pipe member according to claim 1, wherein said large-diameter metal pipe further includes a step part, and said small-diameter metal pipe and said large-diameter metal pipe are fixed in the longitudinal direction through abutment of the expanded part of said small-diameter metal pipe against said step part of the large-diameter metal pipe.

4. The pipe member according to claim 1, wherein the pipe member is a steering hanger beam is adapted to be laid widthwise across an automobile for attaching an instrument panel to a body of the automobile.

5. A method of manufacturing a pipe member, comprising the steps of:
inserting a large-diameter metal pipe into a molding die;
inserting a small-diameter metal pipe into the large-diameter metal pipe from a direction opposite to a direction of insertion of the large-diameter metal pipe;
press-fitting a diameter expanding punch through the large-diameter metal pipe into an end portion of the small-diameter metal pipe, thereby integrally expanding the diameter of the large-diameter metal pipe and the small-diameter metal pipe;
inwardly bending a tip end of an expanded part of the large-diameter metal pipe so that the tip end conforms to a tapered part of the small-diameter metal pipe; and
integrally deforming, radially inwardly or outwardly, a part of an expanded part of said small-diameter metal pipe and a part of the expanded part of said large-diameter metal pipe.

6. The pipe member according to claim 2, wherein the pipe member is a steering hanger beam adapted to be laid widthwise across an automobile for attaching an instrument panel to a body of the automobile.

7. The pipe member according to claim 3, wherein the pipe member is a steering hanger beam adapted to be laid widthwise across an automobile for attaching an instrument panel to a body of the automobile.
